(19) United States
(12) Patent Application Publication
(10) Pub. No.: US 2008/0055513 A1
(43) Pub. Date: Mar. 6, 2008

(54) Liquid crystal display device

(75) Inventor: Masaki Ichio, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/896,076

(22) Filed: Aug. 29, 2007

(30) Foreign Application Priority Data
Aug. 30, 2006 (JP) 2006-233045

(51) Int. Cl. G02F 1/1333

(52) U.S. Cl. 349/58

(57) ABSTRACT

The present invention provides a liquid crystal display module which can prevent an external force from ill-affecting the display even when the external force is applied to the liquid crystal display module. In the liquid crystal display module according to the invention which includes a liquid crystal display panel, a light guide plate and a mold which are arranged on a back surface of the liquid crystal display panel, a metal-made lower frame which is arranged on a light-guide-plate-and-mold side, and a metal-made upper frame which is arranged on a liquid-crystal-display-panel side, a thickness of the lower frame is set larger than a thickness of the upper frame. The thickness of the lower frame is preferably set 1.33 times or more and 2.66 times or less as large as the thickness of the upper frame.

### CROSS-REFERENCE TO RELATED APPLICATIONS

The disclosure of Japanese Patent Application No. 2006-233045 filed on Aug. 30, 2006 including the specification, drawings and abstract is incorporated herein by reference in its entirety.

### BACKGROUND

1. Field of the Invention

The present invention relates to a display device, and more particularly to the constitution of a liquid crystal display module which is used for a display part of a digital still camera.

2. Description of the Related Art

Currently, a liquid crystal display panel has been popularly used as a display device of a mobile phone or a digital still camera. The liquid crystal display panel is constituted by sandwiching a liquid crystal layer between two transparent substrates. When any force is applied to the liquid crystal display panel from the outside, there arises a drawback that a display performed by the liquid crystal display panel is ill-affected. Accordingly, to use the liquid crystal display panel as a display part of the digital still camera, for example, it is necessary to protect the liquid crystal display panel from such a force from the outside.

### SUMMARY

In the conventional liquid crystal display module, drawbacks which arise when the liquid crystal display module is actually mounted on the digital still camera, for example, have not been taken into consideration.

Inventors of the present invention have studied drawbacks which may occur when a liquid crystal display module is mounted on a digital still camera, for example, and it is an object of the present invention to provide a liquid crystal display module which can overcome such drawbacks by performing proper designing of the liquid crystal display module.

According to a first aspect of the present invention, there is provided a liquid crystal display module which includes a liquid crystal display panel, a light guide plate and a mold which are arranged on a back surface of the liquid crystal display panel, a metal-made lower frame which is arranged on a light-guide-plate-and-mold side, and a metal-made upper frame which is arranged on a liquid-crystal-display-panel side, wherein a thickness of the lower frame is set larger than a thickness of the upper frame.

Due to such a constitution, it is possible to provide a liquid crystal display module which can, even when an external force is applied to the liquid crystal display module, prevent the external force from ill-affecting a display part.

To be more specific, it is preferable to set the thickness of the lower frame 1.33 times or more and 2.66 times or less as large as the thickness of the upper frame.

Further, a side surface of the lower frame is formed up to a position where the whole periphery of the side surface is brought into contact with the upper frame. An external force transmitted from the upper frame is received by the side surface of the lower frame and hence, even when some parts of the side surface of the lower frame are brought into contact with the upper frame, such a contact is not effective. Accordingly, it is necessary to form the side surface of the lower frame up to a position where 80% or more of the whole periphery of the side surface is brought into contact with the upper frame.

Further, to take a cost into consideration, the upper frame is formed of a cheap steel plate, and the lower frame is formed of a costly stainless-steel plate.

Further, a lower portion of the side surface of the upper frame is formed up to a position which falls within a range from 0.2 mm or more to 0.4 mm or less from a bending portion of the side surface of the lower frame.

Further, when an optical sheet is mounted on the light guide plate, by setting a distance between the optical sheet and a lower polarizer to 0.2 mm or more and 0.3 mm or less, there is no possibility that the optical sheet is brought into contact with the lower polarizer even when the optical sheet receives an external force and hence, it is possible to obtain a favorable display.

Further, it is desirable to set a thickness of the lower frame to a value which falls within a range from 0.2 mm or more to 0.4 mm or less.

Due to such constitutions, it is possible to provide a liquid crystal display module which can prevent an external force from ill-affecting the display part even when the external force is applied to the liquid crystal display module.

### BRIEF DESCRIPTION OF THE DRAWINGS

FIG. 1 is a view showing the schematic constitution of a liquid crystal display module;

FIG. 2 is a view showing the arrangement of a resin mold 22 and a light guide plate 24 arranged on a lower stainless-steel frame 2;

FIG. 3 is a view showing a cross section taken along a line A-A′ after assembling the liquid crystal display module shown in FIG. 1;

FIG. 4A to FIG. 4C are views showing the liquid crystal display module, wherein FIG. 4A is a view showing another cross section in the vicinity of the cross section taken along the line A-A′ explained in conjunction with FIG. 3, FIG. 4B is a view showing a side surface of the upper stainless-steel frame 1, and FIG. 4C is a view showing a side surface of the lower stainless-steel frame 2;

FIG. 5 is a cross-sectional view of the constitution which houses the liquid crystal display module 10 explained in conjunction with FIG. 1 to FIG. 4 in a casing of a digital still camera, for example;

FIG. 6 is a view for explaining drawbacks when an external force is applied to the liquid crystal display module 10;

FIG. 7 is a view showing the appearance of the digital still camera which incorporates the liquid crystal display module 10 therein;

FIG. 8 is a view showing the constitution of the liquid crystal display module of the present invention;

FIG. 9A is a view showing a state in which a side surface of a lower stainless-steel frame is brought into contact with an upper stainless-steel frame, and FIG. 9B is a view showing another mode in which a side surface of the lower stainless-steel frame is brought into contact with the upper stainless-steel frame; and

FIG. 10 is a view for explaining the importance of thickness.

### DETAILED DESCRIPTION OF THE INVENTION

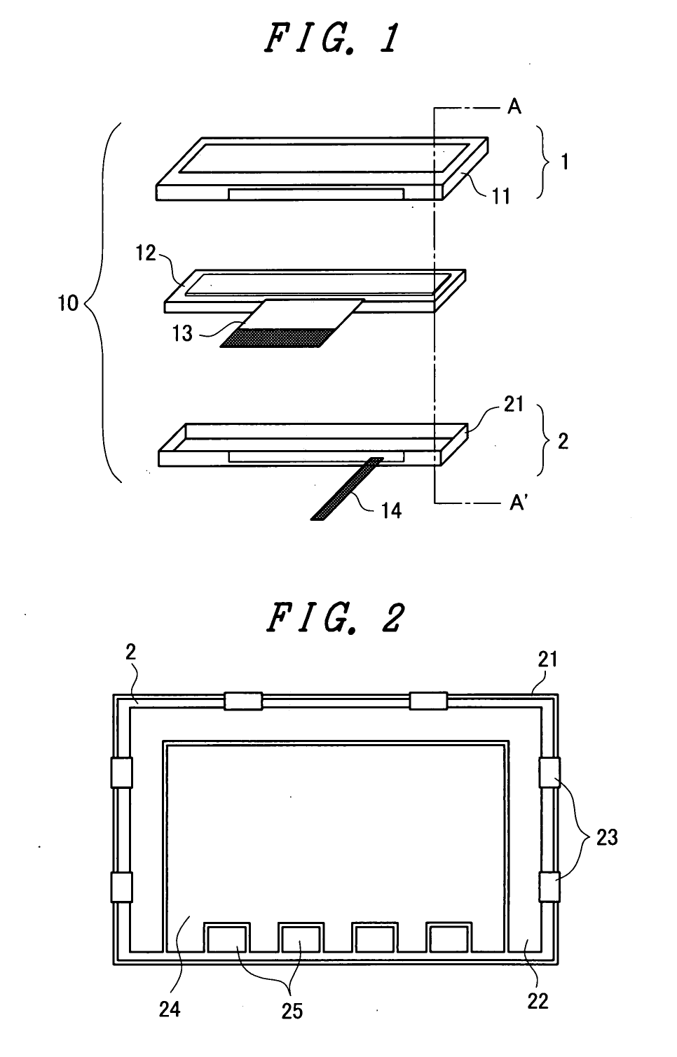

FIG. 1 is a view showing the schematic constitution of a liquid crystal display module 10.

In a liquid crystal display panel 12 which is constituted by sandwiching a liquid crystal layer between two transparent substrates formed of a glass substrate, for example, a flexible printed circuit board 13 is arranged in a periphery of a display region of the liquid crystal display panel 12, and a display is controlled by supplying signals to signal lines and scanning lines which are formed on the display region.

The liquid crystal display module 10 is configured to be sandwiched by an upper stainless-steel frame 1 and a lower stainless-steel frame 2 from above and below.

FIG. 2 is a view showing the arrangement of a resin mold 22 and a light guide plate 24 arranged on the lower stainless-steel frame 2.

A U-shaped resin mold is arranged on the lower stainless-steel frame 2. The resin mold 22 can be arranged at a desired position by engaging pawl portions 23 of the resin mold 22 with holes formed in a side surface 21 of the lower stainless-steel frame 2.

Here, the light guide plate 24 is arranged in the inside of the U-shaped resin mold 22, and light sources 25 such as LEDs are arranged on one side surface of the light guide plate 24.

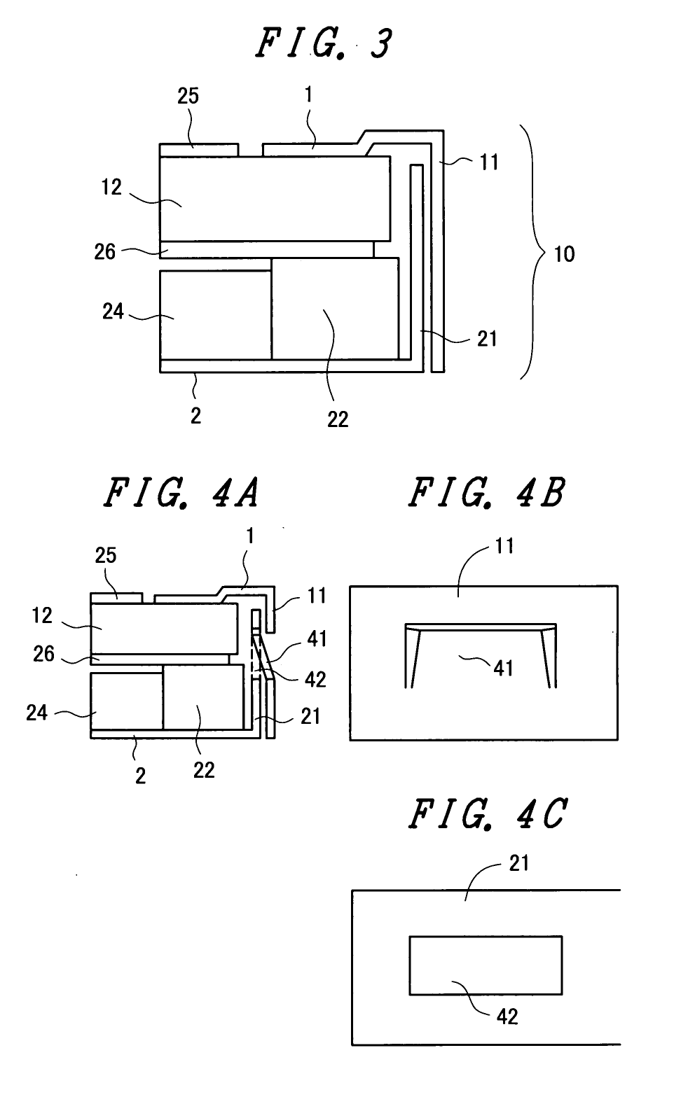

FIG. 3 is a view showing a cross section of the liquid crystal display module taken along a line A-A′ after assembling the liquid crystal display module shown in FIG. 1.

As explained in conjunction with FIG. 2, the light guide plate 24 and the resin mold 22 having a thickness larger than a thickness of the light guide plate 24 are arranged on the lower stainless-steel frame 2. The liquid crystal display panel 12 is arranged above the light guide plate 24 and the resin mold 22. Here, two polarizers, that is, the upper polarizer 25 and the lower polarizer 26 are arranged on the liquid crystal display panel 12. Further, the upper stainless-steel frame 1 is configured to be pushed to the liquid crystal display panel 12.

FIG. 4A is a view showing another cross section of the liquid crystal display module in the vicinity of the cross section taken along the line A-A′ explained in conjunction with FIG. 3.

As shown in FIG. 4B, a cutout portion 41 which has three sides thereof cut out is formed in a side surface 11 of the upper stainless-steel frame 1 and, as shown in FIG. 4C, a hole portion 42 is formed in a portion of the side surface 21 of the lower stainless-steel frame 2 corresponding to the cutout portion 41 formed in the side surface 11 of the upper stainless-steel frame 1.

As shown in FIG. 4A, the upper stainless-steel frame 1 and the lower stainless-steel frame 2 are fixed to each other by engaging the cutout portion 41 of the upper stainless-steel frame 1 with the hole portion 42 of the lower stainless-steel frame 2.

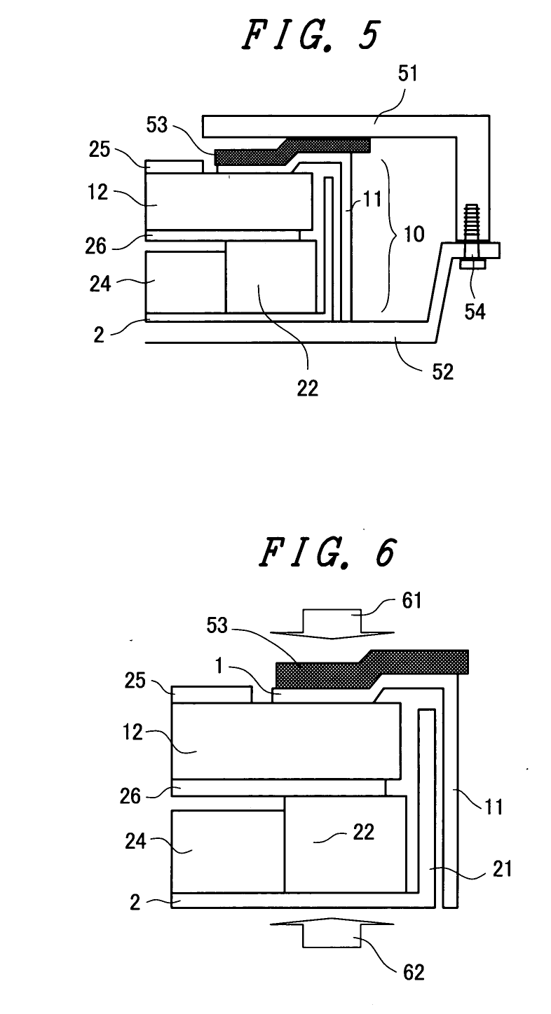

FIG. 5 is a cross-sectional view of the constitution which houses the liquid crystal display module 10 explained in conjunction with FIG. 1 to FIG. 4 in a casing of a digital still camera, for example.

As shown in FIG. 5, the liquid crystal display module 10 is held such that the liquid crystal display module 10 is sandwiched between an upper casing 51 which forms a back cover of the digital still camera and a lower casing 52 which forms a back metal plate. A spacer 53 made of a resilient material such as sponge, rubber or poron is arranged between the upper casing 51 and the liquid crystal display module 10. Here, the upper casing 51 and the lower casing 52 are fixed to each other using bolts 54 or the like at specific positions.

FIG. 6 is a view for explaining drawbacks when an external force is applied to the liquid crystal display module 10.

As shown in FIG. 6, there exists a possibility that an external force 61 from an upper stainless-steel frame 1 side and an external force 62 from a lower stainless-steel frame 2 side are applied to the liquid crystal display module 10.

In the constitution of the liquid crystal display module 10 shown in FIG. 6, when the external force 61 is applied to the liquid crystal display module 10, the force 61 is transmitted to the liquid crystal display panel 12 from the upper stainless-steel frame 1 by way of the spacer 53. Further, when the external force 62 is applied to the liquid crystal display module 10, the force 62 is transmitted to the liquid crystal display panel 12 from the lower stainless-steel frame 2 by way of the resin mold 22. When the force is applied to the liquid crystal display panel 12 from above or below, there arises a drawback that a gap of a liquid crystal layer formed in the inside of the liquid crystal display panel 12 is changed thus giving rise to a drawback that display irregularities are generated and a display is adversely influenced.

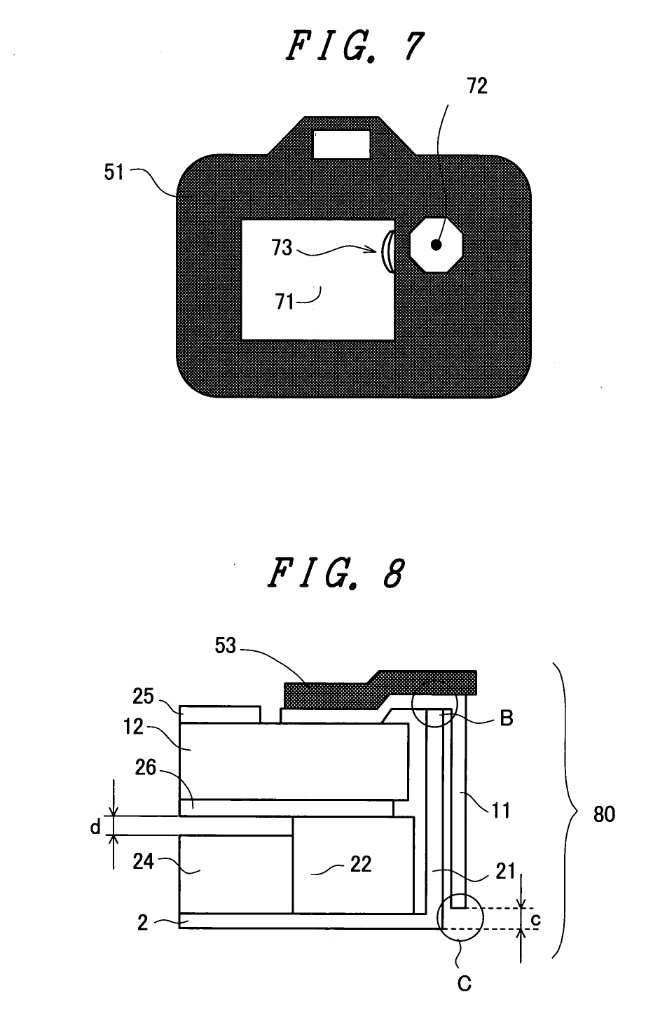

FIG. 7 is a view showing the appearance of the digital still camera which incorporates the liquid crystal display module 10 therein.

A display region 71 of the liquid crystal display panel 12 is visible on the upper casing 51 side which constitutes a back cover, and a camera manipulation button 72 is usually arranged in the vicinity of the display region 71. An operator of the digital still camera holds the upper casing 51 and the lower casing 52 in a sandwiching manner at the time of operating the digital still camera, and in handling the camera manipulation button 72, the operator applies a force in the direction toward the inside of the digital still camera. Such a force becomes the external force 61 or the external force 62 explained in conjunction with FIG. 6 and generates the display irregularities 73 on the display region 71.

In view of such a drawback, FIG. 8 shows the constitution of a liquid crystal display module of the present invention which hardly generates display irregularities even when the liquid crystal display module is mounted on a digital still camera.

A liquid crystal display module 80 according to the present invention is described hereinafter corresponding to the conventional liquid crystal display module 10.

A first technical feature which makes the liquid crystal display module 80 of this embodiment differ from the conventional liquid crystal display module 10 is explained.

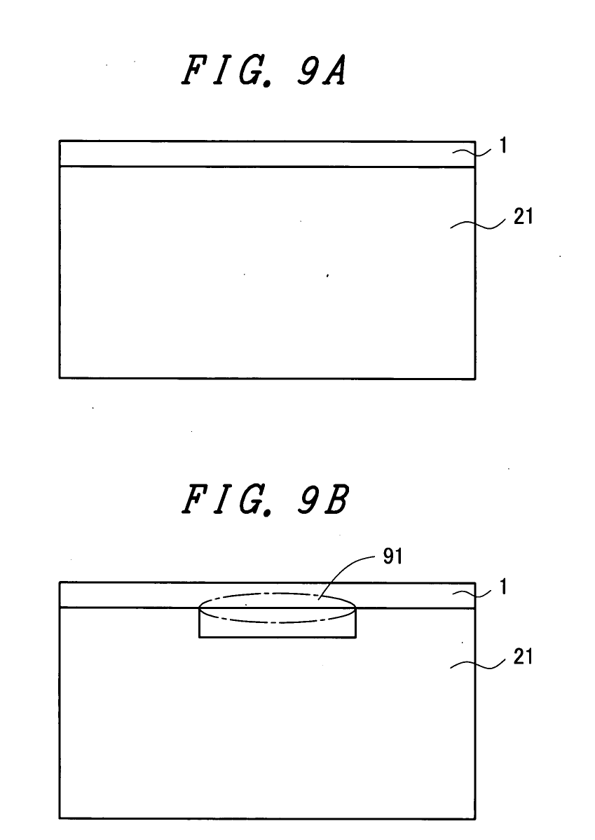

The liquid crystal display module 80 according to the present invention is, as indicated by a portion B in FIG. 8, characterized in that an upper portion of a side surface 21 of a lower stainless-steel frame 2 is arranged to be in contact with an upper stainless-steel frame 1. The contact according to the present invention does not imply a contact only at specific portions but implies, as shown in FIG. 9A, a contact between the whole periphery of an upper portion of the side surface 21 of the lower stainless-steel frame 2 and the upper stainless-steel frame 1.

Due to such a constitution, even when the external force 61 explained in conjunction with FIG. 6 is applied from an upper stainless-steel frame 1 side of the liquid crystal display module 80, the force from the upper stainless-steel frame 1 is transmitted to the lower stainless-steel frame 2 which is brought into contact with the upper stainless-steel frame 1 and hence, the concentration of the force on the liquid crystal display panel 12 can be prevented. To explain this technical feature, as shown in FIG. 9A, the explanation is made with respect to the case in which the whole periphery of the upper portion of the side surface 21 of the lower stainless-steel frame 2 is brought into contact with the upper stainless-steel frame 1. However, as shown in FIG. 9B, even with the constitution in which the upper portion of the side surface 21 of the lower stainless-steel frame 2 is not brought into contact with a specific portion 91 of the upper stainless-steel frame 1, provided that 80% or more of the whole periphery of the upper portion of the side surface 21 of the lower stainless-steel frame 2 is brought into contact with the upper stainless-steel frame 1, it is possible to sufficiently escape the external force 61 to the lower stainless-steel-frame side and hence, there arises no drawback even with such a constitution.

Next, a second technical feature of the liquid crystal display module 80 according to the present invention is explained.

In the liquid crystal display module 80 according to the present invention, a thickness of the upper stainless-steel frame 1 (and the side surface 11) and a thickness of the lower stainless-steel frame 2 (and a side surface 21) differ from each other. That is, the thickness of the lower stainless-steel frame 2 is larger than the thickness of the upper stainless-steel frame 1.

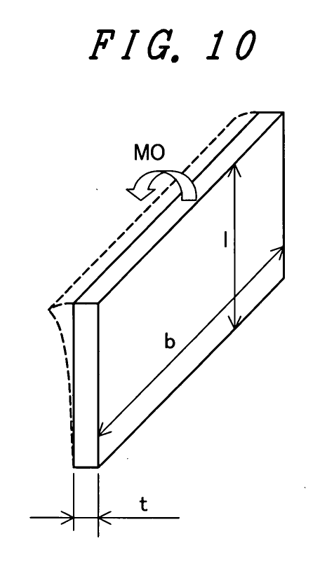

The importance of thickness is explained in conjunction with FIG. 10.

FIG. 10 shows a state in which a plate is pushed from above, wherein a maximum deflection quantity ω can be expressed by a following formula (1).

ωmax=−(M₀·l²)/(2·E·I) (1)

In the formula (1), M₀ indicates a maximum bending moment, l indicates a span, E indicates Young's modulus, and I indicates geometrical moment of inertia. Here, geometrical moment of inertia I is expressed by a following formula (2), wherein b indicates a depth, and t indicates a plate thickness.

I=b·t³/12 (2)

These formulae indicate that the larger the plate thickness, the smaller the deflection quantity of the plate becomes at a rate of three powers of magnification of the plate thickness.

For example, in the conventional structure (FIG. 3), a plate thickness of the upper stainless-steel frame 1 (and the side surface 11) is 1.5 mm and a plate thickness of the lower stainless-steel frame 2 (and the side surface 21) is also 1.5 mm. To the contrary, as shown in FIG. 9, while the plate thickness of the upper stainless-steel frame 1 (and the side surface 11) is 1.5 mm, the plate thickness of the lower stainless-steel frame 2 (and the side surface 21) is 2.0 mm.

In such a design, the plate thickness of the lower stainless-steel frame 2 is 1.33 times (1.5 mm to 2.0 mm) as large as the thickness of the conventional plate thickness of the lower stainless-steel frame 2. Due to such an increase of the plate thickness by 1.33 times, the deflection quantity is decreased at a rate of three powers of 1.33. By adopting such a thickness, even when an external force is applied from above the side surface 21 of the lower stainless-steel frame 2, the side surface 21 is not deflected. Here, the larger the thickness of the lower stainless-steel frame 2, the above-mentioned strength is increased. However, along with the increase of the strength, a weight of the lower stainless-steel frame 2 is increased correspondingly. Accordingly, an upper limit of the lower stainless-steel frame 2 is considered to be approximately 4.0 mm (that is, when the thickness of the upper stainless-steel frame 1 is 1.5 mm, the thickness of the lower stainless-steel frame 2 is considered to be 2.67 times as large as the thickness of the upper stainless-steel frame 1).

Here, although the upper stainless-steel frame and the lower stainless-steel frame have been explained in the present invention heretofore, the present invention is applicable to any metal frame.

Here, as a matter of course, the stainless-steel frame may be used for forming the upper and lower frames in accordance with the embodiment of the present invention. However, according to the present invention, the lower stainless-steel frame is particularly important and hence, the liquid crystal display module may be configured such that the lower stainless-steel frame 2 is used as it is and a metal material of the upper frame may be steel which is cheaper than stainless steel. Stainless steel exhibits a yield strength of 710 MPa, and steel exhibits a yield strength of 320 MPa and hence, the stainless-steel frame exhibits the smaller deflection compared to the steel frame. However, the upper frame is not required to possess a high strength compared to the lower frame in structure and hence, there may arise no problem even when the steel plate is used in place of the stainless-steel frame. Here, both stainless steel and steel exhibit the Young's modulus of approximately 200 GPa.

Next, a third technical feature of the liquid crystal display module 80 according to the present invention is explained.

The third technical feature of the present invention lies in that a distance between the light guide plate 24 and the lower polarizer 26 shown in FIG. 8 is set larger than the corresponding distance of the liquid crystal display module shown in FIG. 3. The distance between the light guide plate 24 and the lower polarizer 26 implies, since a plurality of optical sheets such as a diffusion sheet and a prism sheet is mounted on the light guide plate 23 although not shown in the drawing exactly, a distance from the optical sheet to the lower polarizer 26.

According to the present invention, while the distance is set to 0.13 mm in FIG. 3, the distance of 0.23 mm is ensured in FIG. 8. In this case, although the distance is set to 0.23 mm, it is found that the desirable distance is set to a value which falls within a range from 0.2 mm or more to 0.3 mm or less. This is because that, when the distance is 0.13 mm as in the case of the conventional structure, an external force is applied to the liquid crystal display module from above and below and the optical sheet is adhered to the lower polarizer 26 and hence, the external force is transmitted to the display region by way of the adhered optical sheet thus giving rise to a possibility that a display is adversely affected, while by setting the distance to 0.23 mm as in the case of the present invention, even when an external force is applied to the liquid crystal display module from above and below, a possibility that the optical sheet is brought into contact with the lower polarizer 26 becomes extremely small.

Next, a fourth technical feature of the liquid crystal display module 80 according to the present invention is explained.

The fourth technical feature of the present invention lies in that as indicated in a portion C in FIG. 8, the side surface 11 of the upper stainless-steel frame 1 terminates at a position higher than a folding portion of the side surface 21 of the lower stainless-steel frame 2. In the liquid crystal display module 80 of the present invention, this height c is set to 0.3 mm. This is because that, as explained in conjunction with FIG. 5, since the lower casing 52 of the digital still camera is pushed to the liquid crystal display module 80 from the lower stainless-steel frame 2 side of the liquid crystal display module 80, when the lower portion of the side surface 11 of the upper stainless-steel frame 1 is at the same position as the folding portion of the lower stainless-steel frame 2, it is possible to prevent the lower casing from coming into contact with the side surface 11 of the upper stainless-steel frame 1. Accordingly, by setting the height c to 0.2 mm or more in view of possible errors in designing or the like, it is considered that no problem arises. Further, when the height c is excessively large, the strength of the side surface 11 of the upper stainless-steel frame 1 is weakened. Accordingly, a limit value of the height c is approximately 0.4 mm.

Here, in the embodiment, drawbacks which arise when the liquid crystal display module is mounted on the digital still camera have been explained. It is needless to say, however, that the present invention is applicable to the liquid crystal display module even when the liquid crystal display module is mounted on equipment other than the digital still camera such as a mobile phone or a gaming machine, for example.

What is claimed is:

1. A liquid crystal display module comprising:
a liquid crystal display panel;
a light guide plate and a mold which are arranged on a back surface of the liquid crystal display panel;
a metal-made lower frame which is arranged on a light-guide-plate-and-mold side; and
a metal-made upper frame which is arranged on a liquid-crystal-display-panel side, wherein
a thickness of the lower frame is set larger than a thickness of the upper frame.

2. A liquid crystal display module according to claim 1, wherein the thickness of the lower frame is set to 1.33 times or more and 2.66 times or less as large as the thickness of the upper frame.

3. A liquid crystal display module according to claim 1, wherein a side surface of the lower frame is formed up to a position where the whole periphery of the side surface is brought into contact with the upper frame.

4. A liquid crystal display module according to claim 1, wherein a side surface of the lower frame is formed up to a position where 80% or more of the whole periphery of the side surface is brought into contact with the upper frame.

5. A liquid crystal display module according to claim 1, wherein the upper frame is formed of a steel plate, and the lower frame is formed of a stainless-steel plate.

6. A liquid crystal display module according to claim 1, wherein a lower portion of the side surface of the upper frame is formed up to a position which falls within a range from 0.2 mm or more to 0.4 mm or less from a bending portion of the side surface of the lower frame.

7. A liquid crystal display module according to claim 1, wherein an optical sheet is mounted on the light guide plate, and a distance between the optical sheet and the lower polarizer is set to a value which falls within a range from 0.2 mm or more to 0.3 mm or less.

8. A liquid crystal display module according to claim 1, wherein a thickness of the lower frame is set to a value which falls within a range from 0.2 mm or more to 0.4 mm or less.

9. A liquid crystal display module according to claim 8, wherein a side surface of the lower frame is formed up to a position where the whole periphery of the side surface is brought into contact with the upper frame.

10. A liquid crystal display module according to claim 8, wherein a side surface of the lower frame is formed up to a position where 80% or more of the whole periphery of the side surface is brought into contact with the upper frame.
